(19) United States
(12) Patent Application Publication
(10) Pub. No.: US 2022/0288784 A1
(43) Pub. Date: Sep. 15, 2022

(54) CONTROL DEVICE, CONTROL METHOD, AND PROGRAM

(71) Applicant: JOHNAN Corporation, Uji-shi, Kyoto (JP)

(72) Inventors: Kozo MORIYAMA, Uji-shi (JP); Shin KAMEYAMA, Uji-shi (JP); Truong Gia VU, Uji-shi (JP); Lucas BROOKS, Uji-shi (JP)

(73) Assignee: JOHNAN Corporation, Uji-shi, Kyoto (JP)

(21) Appl. No.: 17/635,009

(22) PCT Filed: Aug. 27, 2020
(86) PCT No.: PCT/JP2020/032336

§ 371 Date: Feb. 14, 2022

(30) Foreign Application Priority Data
Aug. 30, 2019 (JP) 2019-157952

(51) Int. Cl. B25J 9/16

(52) U.S. Cl. CPC B25J 9/1674; B25J 9/1661

(57) ABSTRACT

A control device according to one or more embodiments may execute an initialization process before it causes a robot to perform a task. After the initialization process is done, the control device may cause the robot to perform the task repetitively. On detection of entry of a person into a work area of the robot while the robot is performing the task repetitively, the control device may cause the robot to suspend the task and execute a re-initialization process. After the re-initialization process is done, the control device may cause the robot to perform the task repetitively.

### TECHNICAL FIELD

The present invention relates to a control device, a control method, and a program.

### BACKGROUND ART

Conventional techniques have disclosed devices for monitoring the working environment of a robot (for example, see PTL 1).

A known device for monitoring the working environment of a robot is equipped with a camera for capturing an image of a work area of a robot, and a computer for detecting a moving object based on a result of an image captured by the camera. When the computer detects a moving object and finds that the moving object is approaching the robot, the computer is configured to issue a warning on a display and to handle the situation, for example, by stopping the robot.

### CITATION LIST

### Patent Literature

PTL 1: JP H05-261692 A

### SUMMARY OF INVENTION

### Technical Problem

A conceivable handling of this situation is to cause the robot to suspend a task (work) temporarily when the computer detects that a person has entered the work area of the robot, and to cause the robot to resume the task when the person exits the work area of the robot. If, however, the person who entered the work area of the robot has adjusted a workpiece position or the like, it may be difficult for the robot to resume the task.

The present invention is made to solve the above problem, and aims to provide a control device, a control method, and a program that can cause a robot to resume a task properly, in a case where the task is suspended due to entry of a person into the work area of the robot.

### Solution to Problem

A control device according to the present invention is a device for controlling a robot that performs a task. The control device includes: an initialization process execution section that executes an initialization process before the control device causes the robot to perform the task; a task execution section that causes the robot to perform the task repetitively after the initialization process is done; and a re-initialization process execution section that executes a re-initialization process, in a case where a person enters a work area of the robot while the robot is performing the task repetitively. The task execution section is configured to cause the robot to suspend the task in the case where the person enters the work area of the robot, and to cause the robot to perform the task repetitively after the re-initialization process is done.

In the case where the task is suspended due to entry of a person into the work area of the robot, this configuration executes the re-initialization process and can thereby cause the robot to resume the task properly.

A control method according to the present invention is a method for controlling a robot that performs a task. The control method includes: a step of executing an initialization process before the robot is caused to perform the task; a step of causing the robot to perform the task repetitively after the initialization process is done; a step of causing the robot to suspend the task and executing a re-initialization process, in a case where a person enters a work area of the robot while the robot is performing the task repetitively; and a step of causing the robot to perform the task repetitively after the re-initialization process is done.

A program according to the present invention causes a computer to implement: a procedure for executing an initialization process before a robot is caused to perform a task; a procedure for causing the robot to perform the task repetitively after the initialization process is done; a procedure for causing the robot to suspend the task and executing a re-initialization process, in a case where a person enters a work area of the robot while the robot is performing the task repetitively; and a procedure for causing the robot to perform the task repetitively after the re-initialization process is done.

### Advantageous Effects of Invention

The control device, the control method, and the program according to the present invention can cause the robot to resume a task properly, in the case where the task is suspended due to entry of a person into the work area of the robot.

### BRIEF DESCRIPTION OF DRAWINGS

FIG. 1 is a block diagram showing a general configuration of a robot control system according to the present embodiment.

FIG. 2 is a flowchart describing an operation of the robot control system according to the present embodiment.

FIG. 3 is a flowchart describing a re-initialization process in FIG. 2.

FIG. 4 is a block diagram showing a general configuration of a robot control system according to a modified example of the present embodiment.

### DESCRIPTION OF EMBODIMENTS

An embodiment of the present invention is described below.

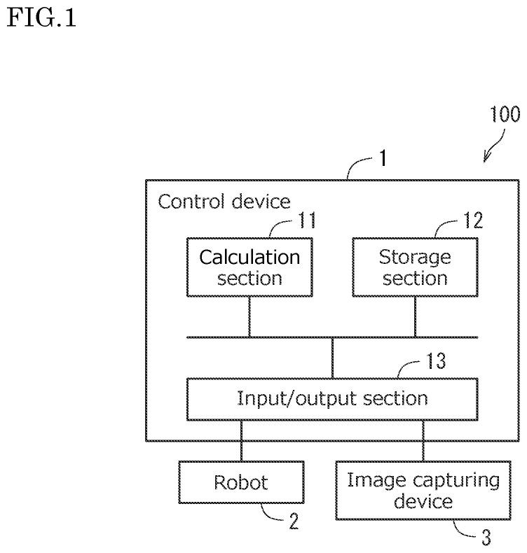

Referring to FIG. 1, a description is made of a configuration of a robot control system 100 that includes a control device 1 according to an embodiment of the present invention.

The robot control system 100 is applied to a factory floor, for example, and is configured to cause a robot 2 to perform a predetermined task (work) on the factory floor. This robot control system 100 does not separate the robot 2 by a fence or the like, and keeps a work area of the robot 2 accessible to a person. As shown in FIG. 1, the robot control system 100 includes the control device 1, the robot 2, and an image capturing device 3.

The control device 1 is configured to control the robot 2 that performs a task. The control device 1 is configured to execute an initialization process before it causes the robot 2 to perform a task, and to cause the robot 2 to perform the task repetitively after the initialization process is done. In causing the robot 2 to perform the task, the control device 1 is adapted to use information obtained by the initialization process.

A task is a work to be done by the robot 2 alone and, for example, includes transferring a workpiece W at a point P1 to a tray T at a point P2. In other words, while workpieces W are sequentially supplied to the point P1, these workpieces W are sequentially transferred to the tray T of the point P2 through repetitive execution of the task by the robot 2. The initialization process includes, for example, calibration for converting the coordinate system of the image capturing device 3 into the coordinate system of the robot 2, recognition of the workpiece and the tray, recognition of the positions and postures of the workpiece and the tray, and setting of a trajectory of the robot 2. When executing the initialization process, the control device 1 executes all of the calibration, the recognition of the workpiece and the tray, the recognition of the positions and postures of the workpiece and the tray, and the setting of the trajectory of the robot 2.

The control device 1 includes a calculation section 11, a storage section 12, and an input/output section 13. The calculation section 11 is configured to control the control device 1 by performing arithmetic processing based on programs and the like stored in the storage section 12. The storage section 12 stores programs and the like. Examples of the programs include a program for causing the robot 2 to perform the task, a program for executing the initialization process for the robot 2, a program for executing the re-initialization process for the robot 2, etc. The input/output section 13 is connected to the robot 2, the image capturing device 3, etc. Note that “the initialization process execution section”, “the task execution section”, and “the re-initialization process execution section” in the present invention are implemented when the calculation section 11 executes the programs stored in the storage section 12. Also note that the control device 1 is an example of “the computer” in the present invention.

The robot 2 has a multi-axis arm and a hand, for example. The multi-axis arm is mounted on a base. The hand, as an end effector, is provided at an extreme end of the multi-axis arm. The robot 2 is configured to hold a workpiece by the hand and to transport the workpiece held by the hand.

The image capturing device 3 is configured to capture an image of a work area of the robot 2, and is installed to detect, for example, entry and exit of a person in the work area of the robot 2. The work area of the robot 2 is an area surrounding the robot 2, and covers an area in which the robot 2 moves and a workpiece held by the robot 2 passes during the work. The result of an image captured by the image capturing device 3 is input to the control device 1. Accordingly, the control device 1 is configured to control the robot 2, based on the result of an image captured by the image capturing device 3 and any other relevant factor.

While the control device 1 causes the robot 2 to perform the task repetitively, the control device 1 may detect entry of a person into the work area of the robot 2, based on the result of an image captured by the image capturing device 3. On detection of such entry, the control device 1 is configured to cause the robot 2 to suspend the task. The control device 1 will later detect exit of the person from the work area of the robot 2, based on the result of an image captured by the image capturing device 3. On detection of such exit, the control device 1 is configured to execute a re-initialization process. After the re-initialization process, the control device 1 is configured to cause the robot 2 to perform the task repetitively. In causing the robot 2 to perform the task, the control device 1 is adapted to use information updated by the re-initialization process.

The re-initialization process includes, for example, re-calibration for converting the coordinate system of the image capturing device 3 into the coordinate system of the robot 2, re-recognition of the workpiece and the tray, re-recognition of the positions and postures of the workpiece and the tray, and re-setting of the trajectory of the robot 2. When executing the re-initialization process, the control device 1 executes, selectively as required, any or all of the re-calibration, the re-recognition of the workpiece and the tray, the re-recognition of the positions and postures of the workpiece and the tray, and the re-setting of the trajectory of the robot 2.

—Operation of the Robot Control System—

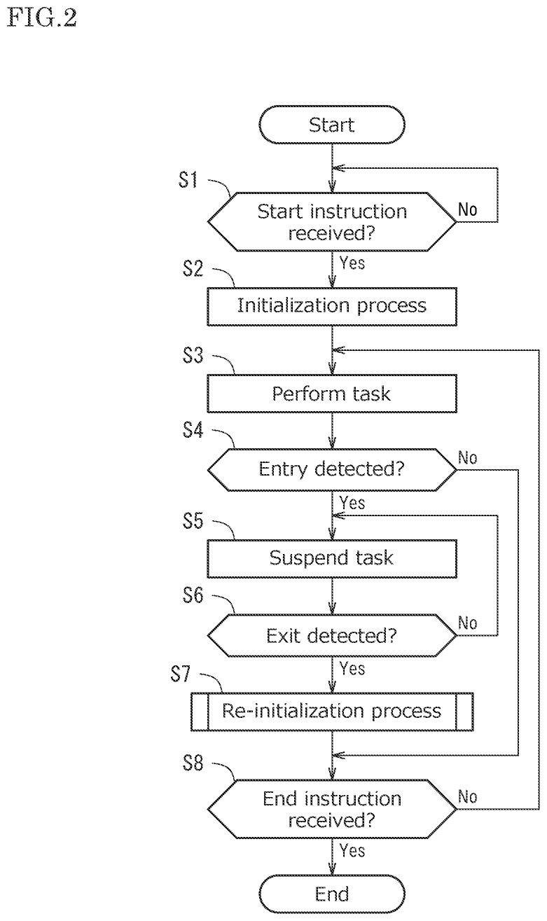

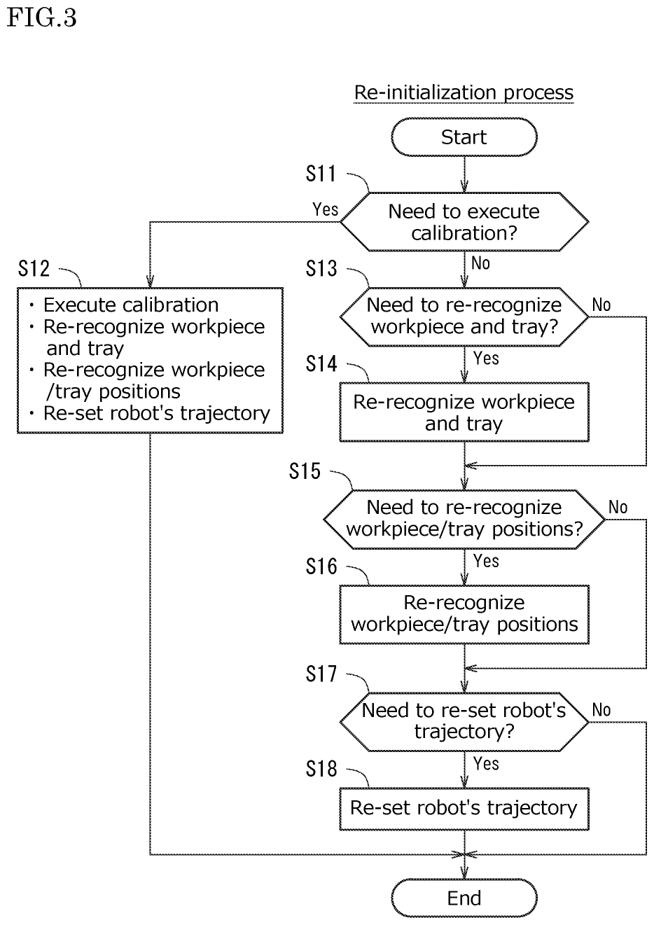

Referring next to FIGS. 2 and 3, a description is made of an operation of the robot control system 100 according to the present embodiment. The following steps are performed by the control device 1.

In step S1 in FIG. 2, the control device 1 determines whether it has received an instruction to start task execution by the robot 2. If the control device 1 determines that it has received an instruction to start the task execution, the process goes to step S2. On the other hand, if the control device 1 determines that it has not received an instruction to start the task execution, step S1 is repeated. In other words, the control device 1 is on standby until it receives an instruction to start the task execution.

In step S2, the control device 1 executes an initialization process for the robot 2. Specifically, the control device 1 executes calibration for converting the coordinate system of the image capturing device 3 into the coordinate system of the robot 2, recognition of the workpiece and the tray, recognition of the positions and postures of the workpiece and the tray, and setting of a trajectory of the robot 2.

In step S3, the control device 1 causes the robot 2 to perform the task. At this time, the control device 1 uses information about the workpiece and the tray recognized in the initialization process, information about the positions and postures of the workpiece and the tray recognized in the initialization process, and information about the trajectory of the robot 2 set in the initialization process. If a re-initialization process has been done in step S7 to be described later, information updated (re-calculated) in the re-initialization process is utilized for task execution.

For example, for a task of transferring the workpiece W at the point P1 to the tray T at the point P2, the initialization process involves calculation of following information, based on the result of an image captured by the image capturing device 3: information about the workpiece W at the point P1, information about the position and posture of the workpiece W, information about the tray T at the point P2, information about the position and posture of the tray T, and information about any obstacle between the points P1 and P2. Then, the control device 1 calculates, for example, a pickup position where the robot 2 picks up the workpiece W by the hand, based on the information about the workpiece W, the information about the position and posture of the workpiece W, and any other relevant information. The control device 1 also calculates, for example, a place position where the robot 2 places the workpiece W by the hand, based on the information about the tray T, the information about the position and posture of the tray T, and any other relevant information. The control device 1 further calculates the trajectory of the robot 2, based on the information about the pickup position, the place position, and the obstacle, and any other relevant information. In this case, a cycle of the task performed by the robot 2 is composed of moving the hand to the pickup position, picking up the workpiece W at the pickup position by the hand, moving the hand from the pickup position to the place position, and placing the workpiece W at the place position by the hand. These actions are conducted sequentially during execution of the task.

In step S4, the control device 1 determines, based on the result of an image captured by the image capturing device 3, whether the control device 1 has detected entry of a person into the work area of the robot 2. If the control device 1 determines that it has detected entry of a person into the work area of the robot 2, the process goes to step S5. On the other hand, if the control device 1 determines that it has not detected entry of a person into the work area of the robot 2 (when no person is present in the work area of the robot 2), the process goes to step S8.

In step S5, the control device 1 causes the robot 2 to suspend the task. Then, for example, the control device 1 causes the robot 2 to retreat to a predetermined retreat position and thereby avoids interference (collision) between the robot 2 and the person who has entered the work area of the robot 2.

In step S6, the control device 1 determines, based on the result of an image captured by the image capturing device 3, whether the control device 1 has detected exit of the person from the work area of the robot 2. If the control device 1 determines that it has detected exit of the person from the work area of the robot 2, the process goes to step S7. On the other hand, if the control device 1 determines that it has not detected exit of the person from the work area of the robot 2 (when the person is present in the work area of the robot 2), the process goes back to step S5. In other words, the robot 2 is kept on standby at the retreat position until the person exits the work area of the robot 2.

In step S7, the control device 1 executes the re-initialization process for the robot 2. The purpose of the re-initialization process is to cause the robot 2 to resume the task properly.

The re-initialization process is described with reference to FIG. 3. In step S11, the control device 1 determines whether to execute re-calibration. For example, re-calibration is determined to be necessary in following cases: where brightness in the work area of the robot 2 has been changed, where the position of a base of the robot 2 has been changed, and where the position of the image capturing device 3 has been changed. If re-calibration is determined to be necessary, the process goes to step S12. On the other hand, if re-calibration is determined to be unnecessary, the process goes to step S13.

In step S12, the control device 1 executes re-calibration, re-recognition of the workpiece and the tray, re-recognition of the positions and postures of the workpiece and the tray, and re-setting of the trajectory of the robot 2. Execution of the process that is similar to the initialization process results in re-alignment of the coordinate system of the robot 2 and the coordinate system of the image capturing device 3, and updating of the various information for execution of the task. After the re-initialization process, the process goes to End (the process goes to step S8 in FIG. 2).

In step S13, the control device 1 determines whether to re-recognize the workpiece and the tray. For example, re-recognition of the workpiece and the tray is determined to be necessary in a case where the workpiece and/or the tray have/has been changed. If re-recognition of the workpiece and the tray is determined to be necessary, the control device 1 re-recognizes the workpiece and the tray in step S14 and updates the information about the workpiece and the tray, and thereafter the process goes to step S15. On the other hand, if re-recognition of the workpiece and the tray is determined to be unnecessary, the process goes to step S15.

In step S15, the control device 1 determines whether to re-recognize the positions and postures of the workpiece and the tray. For example, re-recognition of the positions and postures of the workpiece and the tray is determined to be necessary in a case where the position(s) and posture(s) of the workpiece and/or the tray have been adjusted. If re-recognition of the positions and postures of the workpiece and the tray is determined to be necessary, the control device 1 re-recognizes the positions and postures of the workpiece and the tray in step S16 and updates the information about the positions and postures of the workpiece and the tray, and thereafter the process goes to step S17. On the other hand, if re-recognition of the positions and postures of the workpiece and the tray is determined to be unnecessary, the process goes to step S17.

In step S17, the control device 1 determines whether to re-set the trajectory of the robot 2. For example, re-setting of the trajectory of the robot 2 is determined to be necessary in a case where an obstacle is put on the current trajectory. If re-setting of the trajectory of the robot 2 is determined to be necessary, the control device 1 re-sets the trajectory of the robot 2 in step S18 and updates the information about the trajectory of the robot 2, and thereafter the process goes to End. On the other hand, if re-setting of the trajectory of the robot 2 is determined to be unnecessary, the process goes to End.

Now turning to step S8 in FIG. 2, the control device 1 determines whether it has received an instruction to end the task execution by the robot 2. If the control device 1 determines that it has received an instruction to end the task execution, the execution of the task is terminated, and thereafter the process goes to End. On the other hand, if the control device 1 determines that it has not received an instruction to end the task execution, the process returns to step S3. In other words, the control device 1 causes the robot 2 to perform the task repetitively until the control device 1 receives an instruction to end the task execution.

### Advantageous Effects

As described above, the control device 1 in the present embodiment causes the robot 2 to perform the task repetitively after the initialization process is done. If a person enters the work area of the robot 2 while the robot 2 is performing the task repetitively, the control device 1 causes the robot 2 to suspend the task and executes the re-initialization process. After the re-initialization process is done, the control device 1 causes the robot 2 to perform the task repetitively. According to this configuration, when the task is suspended due to entry of a person into the work area of the robot 2, the present embodiment executes the re-initialization process and can thereby cause the robot 2 to resume the task properly. In a case where the person who entered the work area of the robot 2 has made a change inside the work area of the robot 2, the present embodiment can adapt to the change through the re-initialization process.

When the re-initialization process does not require re-calibration, the present embodiment can reduce the time for the re-initialization process by omitting re-calibration. In cases where the person who entered the work area of the robot 2 has changed the brightness of the work area of the robot 2, the position of the base of the robot 2, and the position of the image capturing device 3, the present embodiment executes re-calibration, and can thereby re-align the coordinate system of the robot 2 and the coordinate system of the image capturing device 3.

When the re-initialization process does not require re-recognition of the workpiece and the tray, the present embodiment can reduce the time for the re-initialization process by omitting re-recognition of the workpiece and the tray. In a case where the person who entered the work area of the robot 2 has changed the workpiece and/or the tray, the present embodiment executes re-recognition of the changed workpiece and/or tray, and can thereby adapt to the change of the workpiece and/or the tray.

When the re-initialization process does not require re-recognition of the positions and postures of the workpiece and the tray, the present embodiment can reduce the time for the re-initialization process by omitting re-recognition of the positions and postures of the workpiece and the tray. In a case where the person who entered the work area of the robot 2 has adjusted the position(s) and posture(s) of the workpiece and/or the tray, the present embodiment executes re-recognition of the adjusted position(s) and posture(s) of the workpiece and/or the tray, and can thereby adapt to the adjustment of the position(s) and posture(s) of the workpiece and/or the tray.

When the re-initialization process does not require re-setting of the trajectory of the robot 2, the present embodiment can reduce the time for the re-initialization process by omitting re-setting of the trajectory of the robot 2. In a case where the person who entered the work area of the robot 2 has put an obstacle on the current trajectory, the present embodiment executes re-setting of the trajectory of the robot 2, and can thereby change the trajectory and avoid the obstacle.

### OTHER EMBODIMENTS

The embodiment disclosed herein is considered in all respects as illustrative and should not be any basis of restrictive interpretation. The scope of the present invention is therefore indicated by the appended claims rather than by the foregoing embodiment alone. The technical scope of the present invention is intended to embrace all variations and modifications falling within the equivalency range of the appended claims.

For example, the above embodiment mentions, but is not limited to, the example of causing the robot 2 to transport a workpiece. Alternatively, the robot may process the workpiece or handle the workpiece otherwise. Further, the above embodiment mentions, but is not limited to, the example of the robot 2 equipped with the multi-axis arm and the hand. Alternatively, any robot structure is possible.

The above embodiment mentions, but is not limited to, the example of relying on the result of an image captured by the image capturing device 3 in order to detect entry and exit of a person in the work area of the robot 2. Alternatively, the embodiment may be arranged to rely on a detection result by a radio-frequency sensor (not shown) in order to detect entry and exit of a person in the work area of the robot. Besides, the image capturing device 3 in the above embodiment may be an area sensor, a line sensor, or an event camera. The embodiment may be further arranged to rely on detection results of a plurality of sensors in a suitable combination in order to detect entry and exit of a person in the work area of the robot.

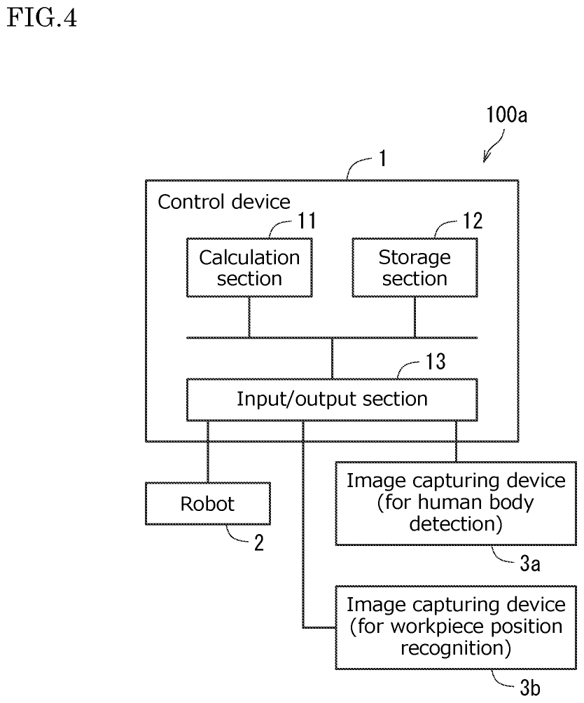

The above embodiment mentions, but is not limited to, the example of providing one image capturing device 3 for the robot control system 100 and using the single image capturing device 3 for detection of a human body and for recognition of a workpiece position. Alternatively, as shown in FIG. 4, a robot control system 100a according to a modified example may be provided with a plurality of image capturing devices 3a and 3b, of which the image capturing device 3a serves for detection of a human body, and the image capturing device 3b serves for recognition of a workpiece position. In other words, the image capturing device 3a for detection of a human body and the image capturing device 3b for recognition of a workpiece position may be provided independently.

The above embodiment mentions, but is not limited to, the example of executing, selectively as required, any or all of the re-calibration, the re-recognition of the workpiece and the tray, the re-recognition of the positions and postures of the workpiece and the tray, and the re-setting of the trajectory of the robot 2, on detection of exit of a person from the work area of the robot 2. Alternatively, irrespective of the necessity, all of the re-calibration, the re-recognition of the workpiece and the tray, the re-recognition of the positions and postures of the workpiece and the tray, and the re-setting of the trajectory of the robot may be executed on detection of exit of a person from the work area of the robot 2.

To determine the necessity of the re-calibration, the re-recognition of the workpiece and the tray, the re-recognition of the positions and postures of the workpiece and the tray, and the re-setting of the trajectory of the robot 2, the above embodiment may rely on the result of an image captured by the image capturing device 3, for example.

On detection of entry of a person into the work area of the robot 2, the above embodiment may be arranged to suspend the task immediately even in the middle of one task cycle or to suspend the task after completion of one task cycle.

### INDUSTRIAL APPLICABILITY

The present invention is applicable to a control device, a control method, and a program for controlling a robot that performs a task.

### REFERENCE SIGNS LIST

1 control device (computer)
2 robot
3, 3a, 3b image capturing device
11 calculation section
12 storage section
13 input/output section
100, 100a robot control system

1. A control device for controlling a robot that performs a task,
the control device comprising:
an initialization process execution section that executes an initialization process before the control device causes the robot to perform the task;
a task execution section that causes the robot to perform the task repetitively after the initialization process is done; and
a re-initialization process execution section that executes a re-initialization process, in a case where a person enters a work area of the robot while the robot is performing the task repetitively,
wherein the task execution section is configured to cause the robot to suspend the task in the case where the person enters the work area of the robot, and to cause the robot to perform the task repetitively after the re-initialization process is done.

2. A control method for controlling a robot that performs a task, the control method comprising:
executing an initialization process before the robot is caused to perform the task;
causing the robot to perform the task repetitively after the initialization process is done;
causing the robot to suspend the task and executing a re-initialization process, in a case where a person enters a work area of the robot while the robot is performing the task repetitively; and
causing the robot to perform the task repetitively after the re-initialization process is done.

3. A non-transitory computer-readable storage medium storing a program for causing, when read and executed, a computer to perform operations comprising:
executing an initialization process before a robot is caused to perform a task;
causing the robot to perform the task repetitively after the initialization process is done;
a causing the robot to suspend the task and executing a re-initialization process, in a case where a person enters a work area of the robot while the robot is performing the task repetitively; and
causing the robot to perform the task repetitively after the re-initialization process is done.
